(19) United States
(12) Patent Application Publication
(10) Pub. No.: US 2014/0135412 A1
(43) Pub. Date: May 15, 2014

(54) METHOD AND APPARATUS FOR REMOVING FOREIGN SUBSTANCES FROM POLYMERS

(71) Applicant: KRONES AG, Neutraubling (DE)

(72) Inventor: Thomas Friedlaender, Neutraubling (DE)

(73) Assignee: KRONES AG, Neutraubling (DE)

(21) Appl. No.: 14/055,451

(22) Filed: Oct. 16, 2013

(30) Foreign Application Priority Data
Nov. 14, 2012 (DE) 102012220785.6

(51) Int. Cl. C08G 85/00; C08J 3/28; B01J 19/08; B01J 19/12; C08J 11/04; B01J 19/00

(52) U.S. Cl. CPC C08G 85/002; C08J 11/04; B01J 19/00; B01J 19/085; B01J 19/12; C08J 3/28
USPC 521/48; 528/272; 526/348; 526/346; 528/335; 528/370; 528/308.1; 422/129; 422/186; 422/243

(57) ABSTRACT

Method for removing a foreign substance from a polymer composition including subjecting a polymer composition to a medium selected from the group comprising chemical reagents, electron beam radiation, electromagnetic radiation, or combinations thereof, removing the transformed foreign substance from the polymer composition, where the foreign substance is by subjecting the polymer composition to the medium at least partially transformed into a form that facilitates removal from the polymer composition. Also, an apparatus for removing a foreign substance from a polymer composition including a device for subjecting a polymer composition to a medium selected from the group comprising chemical reagents, electron beam radiation, electromagnetic radiation, or combinations thereof, and a device for removing the transformed foreign substance from the polymer composition, where the foreign substance is by the device for subjecting the polymer composition to the medium at least partially transformed into a form that facilitates removal from the polymer composition.

### CROSS-REFERENCE TO RELATED APPLICATION

The present application claims the benefit of priority of German Application No. 10 2012 220 785.6, filed Nov. 14, 2012. The entire text of the priority application is incorporated herein by reference in its entirety.

### FIELD OF THE DISCLOSURE

The present disclosure relates to a method for removing a foreign substance from a polymer composition. Furthermore, the disclosure relates to an apparatus for removing a foreign substance from a polymer composition and to the use of a medium in a method or in an apparatus for removing a foreign substance from a polymer composition.

### SUMMARY OF THE DISCLOSURE

Polymer compositions have many applications, for example, as packaging materials, in particular for foods. In this, polymer compositions are often used, in which the polymers are added various foreign substances to improve material properties. In particular fillers are there to be mentioned, such as pigments, etc., barrier materials and the like. In addition, foreign substances from the material to be packaged can enter the polymer composition. Foreign substances, such as e.g. degradation products of the polymers, can also accumulate in the polymer compositions during the production, the use, or during the recycling process.

In light of the scarcity of fossil fuels, polymeric materials, such as packaging materials, are increasingly recycled. In the recycling process, the polymer compositions are generally collected, sorted by mechanical and physical separation methods according to types of material, and then cut into smaller pieces, so-called polymer flakes, and washed. These polymer flakes represent an intermediate product in the recycling process and are re- converted to polymer granules, which can again be transformed into any products, such as food packaging. However, foreign substances remaining in the recycled material pose a problem because these foreign substances can impair the quality and reusability of the recyclate.

A conventional method to separate foreign substances from polymer compositions is described in DE 10 2010 019 824 A1. This document shows a method for the recovery of plastic recyclates from plastic waste reduced to small pieces, in which the plastics waste is treated with an organic solvent in order to remove in particular low molecular organic foreign substances from the material.

Furthermore, volatile foreign substances from polymer flakes can be separated at least partly from the recyclate with the prior art methods, if during the recycling of the polymer recyclate, process steps are performed that take place at high temperatures and at low pressures. In particular solid phase condensation of PET flakes is presently to be mentioned, which is often performed to increase the intrinsic viscosity of the PET material and with which the volatile foreign substances escape from the PET at least partly and can thus be removed.

With the known methods, however, it is often not possible to efficiently and quickly separate all types of foreign substances from polymer compositions.

Therefore, the object of the present disclosure is to provide a method and an apparatus for removing a foreign substance from a polymer composition, in which the foreign substance can be quickly and efficiently separated from the polymer composition, where the expense in energy and equipment for the separation of the foreign substance can be reduced.

### DETAILED DESCRIPTION OF THE PREFERRED EMBODIMENTS

The method according to the present disclosure for removing a foreign substance from a polymer composition comprises the steps of: subjecting a polymer composition to a medium, selected from the group comprising chemical reagents, electron beam radiation, electromagnetic radiation, or combinations thereof, and removing the transformed foreign substance from the polymer composition. By subjecting the polymer composition to the medium, the foreign substance is at least partially transformed into a form that facilitates removal from the polymer composition. The foreign substance can thereby be separated faster and more efficiently from the polymer composition than is the case with the original, non-transformed foreign substance. The expense in energy and equipment for the separation of the foreign substance can thereby be reduced.

Preferably, the transformed foreign substance is selected from the group comprising a decomposition product of the original foreign substance, an energetically excited form of the original foreign substance, a chemically modified form of the original foreign substance, or combinations thereof. The present invention therefore relates in particular to a method in which the polymer composition is subjected to a medium that is able to decompose the foreign substance into an energetically excited form or to chemically modify it. These foreign substances thus transformed can be removed easier and faster from the polymer composition.

The removal is effected in particular by diffusion of the transformed foreign substance from the polymer composition. In this, the transformed foreign substance has a greater diffusion coefficient in relation of the polymeric composition than the original foreign substance. It is in particular preferred that the ratio of the diffusion coefficient of the transformed foreign substance D₂ to the diffusion coefficient of the original foreign substance D₁ (D₂/D₁) is preferably 2 or greater, more preferably 5 or greater, particularly preferably 10 or greater. The term “diffusion coefficient” refers to the diffusion coefficient at the removal temperature, i.e. at the temperature which is given during the step of removing the transformed foreign substance from the polymer composition. Determining the diffusion coefficient is known in prior art and shall presently not be explained in detail. By accelerated diffusion of the transformed foreign substance from the polymer composition, the removal of the foreign substance from the polymer composition can be performed easier and faster. This can be explained in that the diffusion coefficient depends significantly on the size and polarity of the foreign substance, where these factors are changed by the step of subjection to the medium, such that the diffusion coefficient is increased and thereby diffusion is accelerated.

In a preferred embodiment of the present disclosure, the medium is electromagnetic radiation. This electromagnetic radiation is absorbed by the foreign substance, whereby the foreign substance is preferably decomposed, transformed to an energetically excited form, or is chemically modified. It is particularly advantageous that the electromagnetic radiation is selected such, that the foreign substance has a higher absorption coefficient than the polymer in order to achieve increased absorption of the foreign substance in comparison to the polymer. It is in particular preferred that the ratio of the absorption coefficient of the original foreign substance A_{F} to the absorption coefficient of the polymer composition A_{P} (A_{F}/A_{P}) in relation to the electro-magnetic radiation is 2 or greater, preferably 5 or greater, particularly preferably 10 or greater. The term “absorption coefficient” refers to the absorption coefficient at a temperature which is given during the step of subjecting the polymer composition to the medium. The temperature is in particular room temperature, i.e. 20° C. Determining the absorption coefficient is known in prior art and shall presently not be explained in detail.

If the electromagnetic radiation is microwave radiation, then the relevant parameter is not the absorption coefficient, but the dielectric loss factor ∈″. It is to be observed that microwave radiation is selected such, that the foreign substance has a higher dielectric loss factor than the polymer in order to achieve increased excitation of the foreign substance in comparison to the polymer. It is in particular preferred that the ratio of the dielectric loss factor of the original foreign substance ∈″_{F} to the dielectric loss factor of the polymer composition ∈″_{P}(∈″_{F}/∈″_{P}) in relation to the microwave radiation is 2 or greater, preferably 5 or greater, particularly preferably 10 or greater. The term “dielectric loss factor (∈″)” refers to the ∈″ at a temperature that is given during the step of subjecting the polymer composition to the medium. The temperature is in particular room temperature, i.e. 20° C. Determining the dielectric loss factor is known in prior art and shall presently not be explained in detail.

Preferably the electromagnetic radiation is selected from the group comprising gamma radiation, X-rays, UV radiation, IR radiation or microwave radiation. IR radiation is particularly preferred. The electro-magnetic radiation can comprise a wavelength range, i.e. be radiation comprising a range of different wavelengths. The present invention, however, in particular relates to the irradiation of electromagnetic radiation of a specific wavelength, i.e. monochromatic radiation. This has the advantage that wavelengths can specifically be irradiated with which the foreign substance is excited better than the polymer. Emitter emitting a wavelength range as well as monochromatic emitters emitting a defined wavelength are known for many wavelength ranges. As optical monochromatic radiation sources, preferably laser or monochromators with prism grating reflection are used according to the invention. A frequency of 2.45 GHz is preferably used for microwave radiation.

The wavelength of the electromagnetic radiation is not critical per se, but is in particular chosen such that the above conditions are satisfied, i.e. that the foreign substance is excited better than the polymer. For the selection of the wavelength or of the wavelength range, respectively, there is in particular a comparison of the absorption spectra of the polymer and the foreign substance being present in the polymer composition, where the wavelength of the electromagnetic radiation is selected such, that the polymer has an absorption coefficient as low as possible whereas the foreign substance has an absorption coefficient as high as possible. The same applies to the dielectric loss factor for microwave radiation.

With PET flakes being the polymer composition, for example, suitable electro-magnetic radiation is IR radiation in the range from 2700 to 1750 cm⁻¹ because PET absorbs primarily in the range up to 3000 cm⁻¹ and from 1750 to 750 cm⁻¹. Furthermore, in the range from 2700 to 1750 cm⁻¹, many organic foreign substances, such as toluol or benzophenone, exhibit vibrational bands. These foreign substances can preferably be exited (i.e. better than the PET), which accelerates diffusion from the polymer composition and thereby allows faster and more efficient removal of these foreign substances.

Alternatively or in combination, the medium in the present method can be a chemical reagent. Preferably, the chemical reagent is an oxidizing agent, such as hydrogen peroxide or peracetic acid. Furthermore, the chemical reagent can be a reducing agent such as hydrogen. Such an embodiment is selected in particular when the foreign substances is susceptible to the chemical reagent, i.e. is in particular more susceptible to oxidation or reduction than the polymer composition. Further, the chemical reagent can be an acid or a base, i.e. induce a pH change in the polymer composition. In the treatment of the polymer composition with the chemical reagent, there is a chemical reaction of the foreign substance with the chemical reagent. In this, the foreign substance is preferably decomposed, transformed into an energetically excited form, or chemically modified, where the foreign substance thus transformed can be removed more easily and faster from the polymeric composition than the original foreign substance.

According to the present disclosure, polymer compositions are comprised that have a polymer or a combination of several polymers as a main component. The polymer is in particular selected from the group comprising polyester, polyolefins, polystyrenes, polyamides and polycarbonates, preferably PET, or copolymers thereof. The polymer composition is in particular bottle material to be recycled, preferably PET flakes.

The method can be applied to all foreign substances that are given in polymer compositions. Examples of foreign materials are inorganic or organic substances such as fillers, pigments, barrier materials, flame retardants, reinforcing agents, etc. In addition, foreign substances are comprised that enter the polymer composition during the manufacturing process, the use, or during the recycling process or accumulate there. The foreign substance can in particular be organic material which is preferably selected from the group comprising aliphatic hydrocarbons, halogenated hydrocarbons, aromatic hydrocarbons, or substituted derivatives thereof. The foreign substance can be selected in particular from the group comprising C₃-C₂₀, linear, branched or cyclic hydrocarbons, C₆-C₂₀ aromatic hydrocarbons which are optionally substituted by one or more heteroatoms. Heteroatoms are in particular oxygen, nitrogen, or halogens. Examples of foreign substances are selected from the group comprising acetaldehyde, chloroform, toluol, phenylcyclohexane, benzophenone, or combinations thereof.

The present disclosure further relates to an apparatus for removing a foreign substance from a polymer composition comprising a device for subjecting the polymer composition to a medium selected from the group comprising chemical reagents, electron beam radiation, electromagnetic radiation, or combinations thereof, and a device for removing the transformed foreign substance from the polymer composition. In this, the foreign substance is by the device for subjecting the polymer composition to the medium at least partially transformed into a form that facilitates removal from the polymer composition. Thereby, the apparatus can separate the foreign substance faster and more efficiently from the polymer composition than is the case with the original, non-transformed foreign substance. The apparatus can therefore be operated with less expense in energy and equipment.

Preferably, the device for subjecting the polymer composition is a chemical treatment facility, such as a washing facility or a spraying facility when the medium is a chemical reagent. The device can further be an electron beam radiation facility, when the medium is electron beam radiation. The device can be a radiation facility, when the medium is electromagnetic radiation.

Preferably, the device for removing the decomposition products of the foreign substance from the polymer composition is selected from the group comprising a solvent treatment apparatus, a vacuum apparatus, a heating apparatus, or combinations thereof.

The present disclosure also relates to the use of a medium selected from the group comprising chemical reagents, electron beam radiation, electromagnetic radiation, or combinations thereof, in a method or in an apparatus for removing a foreign substance from a polymer composition, where the foreign substance is by subjecting the polymer composition to a medium at least partially transformed into a form that facilitates removal of the polymer composition.

The preferred embodiments being described in relation to the method also apply to the apparatus and the use, respectively.

What is claimed is:

1. A method for removing a foreign substance from a polymer composition comprising:
subjecting a polymer composition to a medium selected from the group comprising chemical reagents, electron beam radiation, electromagnetic radiation, or combinations thereof; removing said transformed foreign substance from said polymer composition, that wherein by subjecting said polymer composition to said medium, said foreign substance is at least partially transformed into a form that facilitates removal from said polymer composition.

2. The method according to claim 1, wherein said transformed foreign substance is selected from the group comprising a decomposition product of said original foreign substance, an energetically excited form of said original foreign substance, a chemically modified form of said original foreign substance, or combinations thereof.

3. The method according to claim 1, wherein removing said transformed foreign substance is performed by diffusion from said polymer composition, wherein said transformed foreign substance has a greater diffusion coefficient in relation to said polymer composition than said original foreign substance, wherein the ratio of said diffusion coefficient of said transformed foreign substance D2 to the diffusion coefficient of said original foreign substance D1 (D2/D1) is 2 or greater.

4. The method according to claim 1, wherein said medium is electro-magnetic radiation, where the ratio of the absorption coefficient of said original foreign substance AF to the absorption coefficient of said polymer composition AP (AF/AP) in relation to said electro-magnetic radiation is 2 or greater.

5. The method according to claim 4, wherein the electromagnetic radiation is selected from the group comprising gamma radiation, X-rays, UV radiation, IR radiation or microwave radiation.

6. The method according to claim 4, wherein said electro-magnetic radiation is IR radiation, preferably monochromatic IR radiation.

7. The method according to claim 1, wherein the medium comprises a chemical reagent, where said chemical reagent is preferably selected from the group comprising oxidizing agents including one of hydrogen peroxide or peracetic acid, reducing agents, including hydrogen, acids or bases.

8. The method according to claim 1, wherein the polymer composition contains a polymer as a main component, which is selected from the group comprising polyester, polyolefins, polystyrenes, polyamides or polycarbonates, in particular PET, or copolymers thereof.

9. The method according to claim 1, wherein the polymer composition is PET bottle material to be recycled.

10. The method according claim 1, wherein the foreign substance is organic material selected from the group comprising aliphatic hydrocarbons, halogenated hydrocarbons, aromatic hydrocarbons, or substituted derivatives thereof.

11. The method according to claim 1, wherein the foreign substance is selected from the group comprising C3-C20, linear, branched or cyclic hydrocarbons, C6-C20 aromatic hydrocarbons, which are optionally substituted by one or more heteroatoms.

12. An apparatus for removing a foreign substance from a polymer composition comprising: a device for subjecting a polymer composition to a medium selected from the group comprising chemical reagents, electron beam radiation, electromagnetic radiation, or combinations thereof, and a device for removing said transformed foreign substance from said polymer composition, characterized in that said foreign substance is by said device for subjecting said polymer composition to said medium at least partially transformed into a form that facilitates removal from said polymer composition.

13. The apparatus according to claim 12, wherein the device for subjecting said polymer composition is a chemical treatment facility, such as a washing facility or a spraying facility, when said medium is a chemical reagent, or that said device is an electron beam radiation facility, when said medium is electron beam radiation, or that said device is a radiation facility, when the medium is electromagnetic radiation.

14. The apparatus according to claim 12 wherein the device for removing the decomposition products of said foreign substance from said polymer composition is selected from the group comprising a solvent treatment apparatus, a vacuum apparatus, a heating apparatus, or combinations thereof.

15. Use of a medium selected from the group comprising chemical reagents, electron beam radiation, electromagnetic radiation, or combinations thereof, in a method or in an apparatus for removing a foreign substance from a polymer composition, characterized in that said foreign substance is by subjecting said polymer composition to a medium at least partially transformed into a form that facilitates removal of said polymer composition.

16. The method according to claim 3, wherein the ration of the diffusion coefficient of the transformed foreign substance D₂ to the diffusion coefficient of the original foreign substance D₁ (D₂/D₁) is 5 or greater.

17. The method according to claim 3, wherein the ratio of the diffusion coefficient of the transformed foreign substance D2 to the diffusion coefficient of the original foreign substance D₁(D₂/D₁) is 10 or greater.

18. The method according to claim 4, wherein the ratio of the absorption coefficient of the original foreign substance AF to the magnetic radiation is 5 or greater.

19. The method according to claim 4, wherein the ratio of the absorption coefficient of the original foreign substance AF to the magnetic radiation is 10 or greater.

20. The method according to claim 9, wherein the polymer material composition is PET flakes.
